(19) United States
(12) Patent Application Publication
(10) Pub. No.: US 2019/0375345 A1
(43) Pub. Date: Dec. 12, 2019

(54) FOLDING INTERIOR LINING PANEL OF A MOTOR VEHICLE

(71) Applicants: TREVES PRODUCTS, SERVICES & INNOVATION, Paris (FR); HONDA MOTOR CO., LTD., Tokyo (JP)

(72) Inventor: Christophe BLOM, Reims (FR)

(21) Appl. No.: 16/464,524

(22) PCT Filed: Nov. 28, 2017
(86) PCT No.: PCT/FR2017/053278

§ 371 Date: May 28, 2019

(30) Foreign Application Priority Data
Nov. 29, 2016 (FR) 1661660

(51) Int. Cl. B60R 13/01

(52) U.S. Cl. CPC B60R 13/013; B60R 2013/018; B60R 2013/015

(57) ABSTRACT

The invention relates to a panel for a motor vehicle having flaps pivotably connected to one another about two respective pivoting edges. The pivotable connection between the flaps has at least two first strips arranged at a distance from one another and at least one second strip arranged between the first strips, the strips being resilient and being mounted under permanent tension in order to ensure a return of the edges towards one another in every configuration of the panel.

### CROSS-REFERENCE TO RELATED APPLICATION

This application claims the benefit of International application number PCT/FR2017/053278, filed Nov. 28, 2017 and French application number 1661660, filed Nov. 29, 2016 the entire contents of which are incorporated herein by reference.

### TECHNICAL FIELD

The invention relates to a folding interior lining panel of a motor vehicle.

### BACKGROUND

It is known to provide a folding interior lining panel of a motor vehicle, the panel having the following characteristics:
it comprises a first and a second flap of similar thickness, the flaps being pivotably connected to one another about two respective pivoting edges to make it possible for a rotation of substantially 360° of one of the flaps with respect to the other, such that the panel can have a configuration of use, where the flaps are in the extension of one of the other to define a receiving surface, and two retracted configurations corresponding to a folding of 180° in one direction or in the other, the panels each having a first face and a second face, the first faces defining the receiving surface,
the pivotable connection between the flaps is provided by:
   at least two first strips arranged at a distance from one another, the first strips each having a median portion, a first extreme fixing portion on the first flap and a second extreme fixing portion on the second flap, the strips being fixed such that the median portion extends from the first face of the first flap to the second face of the second flap,
   at least one second strip arranged between the first strips, the second strip having a median portion, a first extreme fixing portion on the first flap and a second extreme fixing portion on the second flap, the strips being fixed such that the median portion extends from the second face of the first flap to the first face of the second flap.

The folding panel is in particular intended to cover luggage or the floor of a luggage compartment.

The fact of having two retracted configuration is, for example, imposed, in the case of a panel for covering a luggage compartment floor, by the fact that one face of the flaps can be covered with textile, for example in the form of carpeting, the other face being covered with a washable cover, in particular of the type of a plastic material sheet.

Thus, when the folding panel is in a retracted configuration, it can be arranged against a wall of the luggage compartment by exhibiting a washable face, which can prove to be useful when the compartment is loaded with a dirty load.

With the known arrangement, it is difficult to ensure a good contact between the panels in the different configurations, and in particular, that of use, such a contact requiring a very precise controlling of the length of the strips.

This results in, in particular in the configuration of use, the risk of an unsightly space appearing between the panels.

### SUMMARY OF THE INVENTION

The invention aims to overcome this disadvantage.

To this end, the invention proposes a folding interior lining panel of a motor vehicle, the panel having the following characteristics:
it comprises a first and a second flap of similar thickness, the flaps being pivotably connected to one another about two respective pivoting edges to make it possible for a rotation of substantially 360° of one of the flaps with respect to the other, such that the panel can have a configuration of use, where the flaps are in the extension of one of the other to define a receiving surface, and two retracted configurations corresponding to a folding of 180° in one direction or in the other, the panels each having a first face and a second face, the first faces defining the receiving surface,
the pivotable connection between the flaps is provided by:
   at least two first strips arranged at a distance from one another, the first strips each having a median portion, a first extreme fixing portion on the first flap and a second extreme fixing portion on the second flap, the strips being fixed such that the median portion extends from the first face of the first flap to the second face of the second flap,
   at least one second strip arranged between the first strips, the second strip having a median portion, a first extreme fixing portion on the first flap and a second extreme fixing portion on the second flap, the strips being fixed such that the median portion extends from the second face of the first flap to the first face of the second flap,

the strips being resilient and being mounted under permanent tension in order to ensure a return of the edges towards one another in every configuration of the panel.

With the proposed arrangement, due to the strips being resilient—the resilience thereof being leveraged in the median portion thereof—and mounted under permanent tension, in configuration of use or retracted configurations, the risk of an unsightly space appearing between the panels is avoided.

### BRIEF DESCRIPTION OF THE DRAWING

Other particularities and advantages of the invention will appear in the following description, made in reference to the appended figures, wherein:

FIGS. 1a and 1b are schematic, perspective views of a panel according to one embodiment, the panel being in configuration of use (FIG. 1a) and retracted configuration (FIG. 1b),

FIGS. 2a and 2b are schematic, partial cross-sectional views along a median plane passing through a second strip of the panel of FIG. 1, the panel being in configuration of use (FIG. 2a) and retracted configuration (FIG. 2b),

FIG. 3 is a schematic, partial view of the panel of the preceding figures, the flaps being spaced from one another to view the manner of which a first and a second strip are fixed,

FIG. 4 is a schematic view of a strip seen from the front according to one embodiment where the strip is provided with connectors,

FIG. 5 is a schematic, partial, perspective view of a flap according to one embodiment.

### DETAILED DESCRIPTION

In reference to the figures, a folding interior lining panel 1 of a motor vehicle is described, the panel having the following characteristics:
it comprises a first 2 and a second 3 flap of similar thickness, the flaps being pivotably connected to one another about two respective pivoting edges 4 to make it possible for a rotation of substantially 360° of one of the flaps with respect to the other, such that the panel can have a configuration of use, where the flaps are in the extension of one of the other to define a receiving surface 5, and two retracted configurations corresponding to a folding of 180° in one direction or in the other, the panels each having a first face 6 and a second face 7, the first faces 6 defining the receiving surface,
the pivotable connection between the flaps is provided by:
   at least two first strips 8 arranged at a distance from one another, the first strips each having a median portion 9, a first extreme fixing portion 10 on the first flap and a second extreme fixing portion 11 on the second flap, the strips being fixed such that the median portion extends from the first face of the first flap to the second face of the second flap,
   at least one second strip 12 arranged between the first strips, the second strip having a median portion 13, a first extreme fixing portion 14 on the first flap and a second extreme fixing portion 15 on the second flap, the strips being fixed such that the median portion extends from the second face of the first flap to the first face of the second flap,

the strips being resilient and being mounted under permanent tension in order to ensure a return of the edges towards one another in every configuration of the panel.

According to the embodiment represented, the panel 1 furthermore has the following characteristics:
a first strip 8 has a first extreme portion 10 fixed on the first face 6 of the first flap 2 and a second extreme portion 11 fixed on the second face 7 of the second flap 3,
a second strip 12 has a first extreme portion 14 fixed on the second face 7 of the first flap 2 and a second extreme portion 15 fixed on the first face 6 of the second flap 3.

To summarise, in other words, the characteristics described above, a folding interior lining panel 1 of a motor vehicle is described, the panel having the following characteristics:
it comprises a first 2 and a second 3 flap of similar thickness, the flaps being pivotably connected to one another about two respective pivoting edges 4 to make it possible for a rotation of substantially 360° of one of the flaps with respect to the other, such that the panel can have a configuration of use, where the flaps are in the extension of one of the other to define a receiving surface 5, and two retracted configurations corresponding to a folding of 180° in one direction or in the other, the panels each having a first face 6 and a second face 7, the first faces 6 defining the receiving surface,
the pivotable connection between the flaps is provided by:
   at least two first strips 8 arranged at a distance from one another, the first strips each having a median portion 9, a first extreme portion 10 fixed on the first face of the first flap and a second extreme portion 11 fixed on the second face of the second flap,
   at least one second strip 12 arranged between the first strips, the second strip having a median portion 13, a first extreme portion 14 fixed on the second face of the first flap and a second extreme portion 15 fixed on the first face of the second flap,

the strips being resilient and being mounted under permanent tension in order to ensure a return of the edges towards one another in every configuration of the panel.

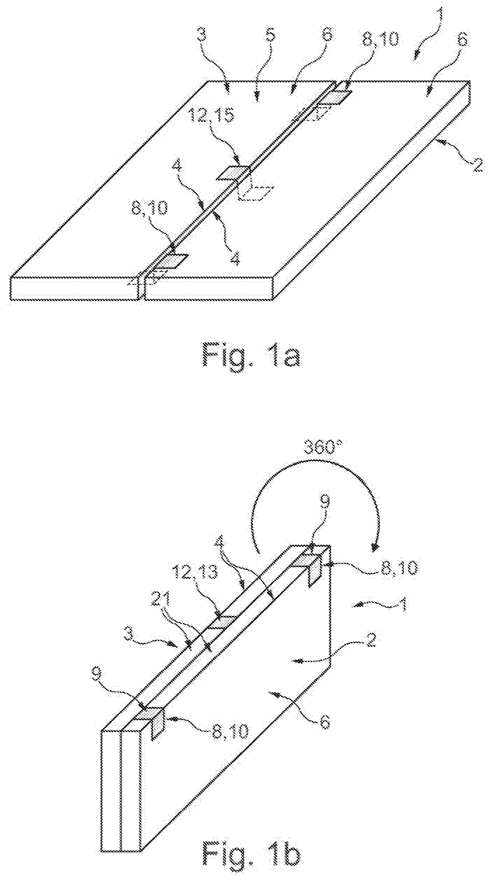

According to the embodiment represented, as seen in FIGS. 1, two first strips 8 are arranged substantially at the ends of the edges 4.

According to the embodiment represented, as seen in FIGS. 1, the panel 1 is provided with a second single strip 12 arranged in the median portion of the pivoting edges 4.

In variants not represented, more first strips 8 can be provided, and also more than one single second strip 12.

The strips 8, 12 can, with no limitation, be positioned alternately and/or by series.

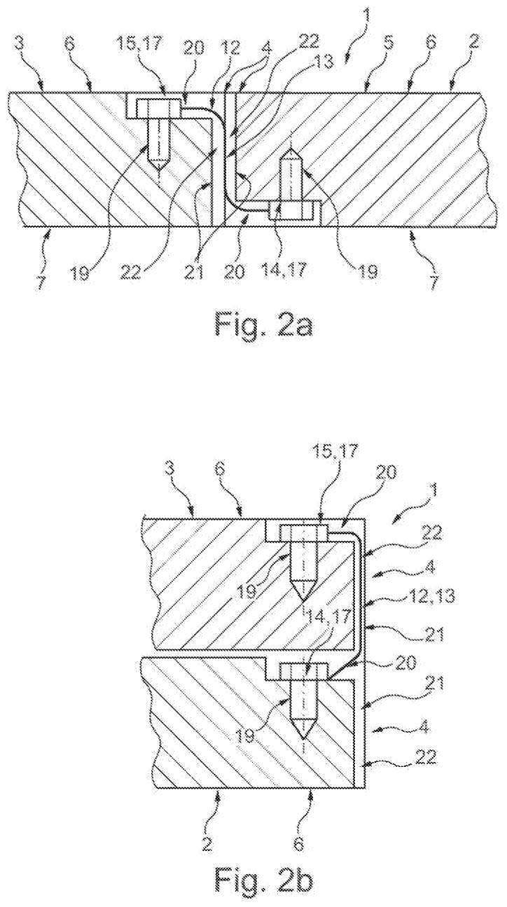

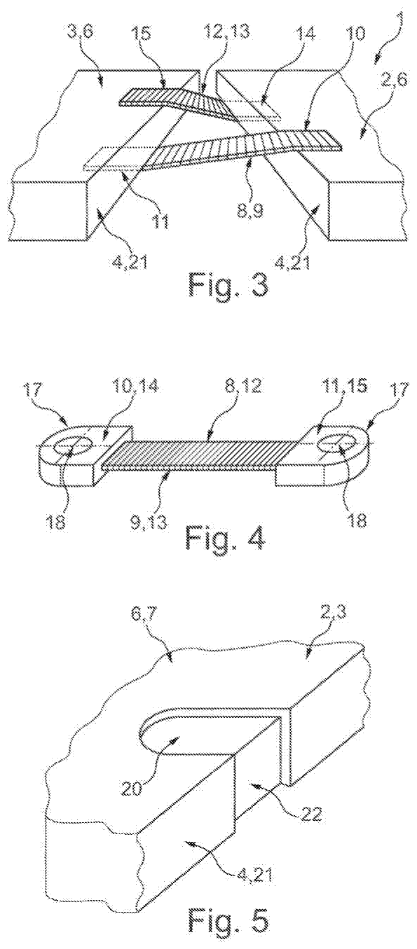

According to one embodiment, as seen in FIGS. 2 and 4, the extreme portions 10, 11, 14, 15 of the strips 8, 12 are overmoulded by fixing connectors 17, the connectors being associated with the corresponding flaps 2, 3 to ensure the fixing of the strips on the flaps.

According to this embodiment, the connectors 17 are provided with a fixing orifice 18 receiving an anchoring member 19 on the corresponding flap 2, 3, the member being in particular in the form of a screw or of a rivet.

According to the embodiment represented in FIG. 5, the flaps 2, 3 are provided with housings 20 for receiving the extreme portions 10, 11, 14, 15 of the strips 8, 12 and/or the connectors 17, such that the extreme portions and/or the connectors do not protrude with respect to the flaps.

According to this embodiment, the rims 21 of the pivoting edges 4 are provided with housings 22 for receiving the median portions 9, 13 of the strips 8, 12, such that the median portions do not protrude with respect to the rims, in order to make it possible for an optimal juxtaposition of the flaps 2, 3 in the configuration of use.

According to an embodiment not represented, the flaps 2, 3 are covered, at least on the first face 6 thereof, with a first covering layer, the extreme portions 10, 11, 14, 15 and/or connectors 17 covering the layer.

According to an embodiment not represented, the flaps 2, 3 are covered, also on the first face 7 thereof, with a second covering layer, the extreme portions 10, 11, 14, 15 and/or connectors 17 covering the layer.

In a variant not represented, it could be provided for the extreme portions 10, 11, 14, 15 and/or connectors 17 to be arranged between the flaps 2, 3 and at least one covering layer, to be masked.

What is claimed is:

1. A folding interior lining panel of a motor vehicle, the panel having the following characteristics:
comprising a first and a second flap of similar thickness, the flaps being pivotably connected to one another about two respective pivoting edges adapted for a rotation of substantially 360° of one of the flaps with respect to the other, such that the flaps are in the extension of one of the other to define a receiving surface, and two retracted configurations corresponding to a folding of 180° in one direction or in the other, the panels each having a first face and a second face, the first faces defining the receiving surface,
the pivotable connection between the flaps further comprising
at least two first strips arranged at a distance from one another, the first strips each having a median portion, a first extreme fixing portion on the first flap and a second extreme fixing portion on the second flap, the strips being fixed such that the median portion extends from the first face of the first flap to the second face of the second flap,
at least one second strip arranged between the first strips, the second strip having a median portion, a first extreme fixing portion on the first flap and a second extreme fixing portion on the second flap, the strips being fixed such that the median portion extends from the second face of the first flap to the first face of the second flap,
the panel wherein the strips are resilient and are mounted under permanent tension of the edges towards one another in every configuration of the panel.

2. A panel according to claim 1, further comprising:
a first strip having a first extreme portion fixed on the first face of the first flap and a second extreme portion fixed on the second face of the second flap,
a second strip has a first extreme portion fixed on the second face of the first flap and a second extreme portion fixed on the first face of the second flap.

3. The panel according to claim 1, wherein the two first strips are arranged substantially at the ends of the edges.

4. The panel according to claim 1, wherein the extreme portions of the strips are overmoulded by fixing connectors, the connectors being associated with the corresponding flaps to ensure the fixing of the strips on the flaps.

5. The panel according to claim 4, wherein the connectors are provided with a fixing orifice receiving an anchoring member on the corresponding flap, the member being in particular in the form of a screw or of a rivet.

6. The panel according to claim 1, wherein the flaps are provided with housings for receiving the extreme portions of the strips and/or the connectors, such that the extreme portions and/or the connectors do not protrude with respect to the flaps.

7. The panel according to claim 1, wherein the rims of the pivoting edges are provided with housings for receiving the median portions of the strips such that the median portions do not protrude with respect to the rims.

8. The panel according to claim 1, wherein the flaps are covered, at least on the first face of the panel, with a first covering layer, the extreme portions and/or connectors covering the player.

9. The panel according to claim 1, wherein the extreme portions and/or connectors are arranged between the flaps and at least one covering layer, to be masked.
